(19) United States
(12) Patent Application Publication
(10) Pub. No.: US 2009/0124488 A1
(43) Pub. Date: May 14, 2009

(54) Substrate with Spatially Selective Metal Coating, Method for Production and Use Thereof

(75) Inventors: Jurgen Hofinger, Dresden (DE); Wolfgang Pompe, Hartha (DE); Michael Mertig, Dresden (DE); Alexander Kirchner, Niesky (DE); Nina Schreiber, Dresden (DE); Anja Bluher, Dresden (DE); Steffen Roos, Dresden (DE); Daniela Keck, Dresden (DE); Beate Katzschner, Reinhardtsdorf (DE)

Correspondence Address: GUDRUN E. HUCKETT DRAUDT, SCHUBERTSTR. 15A, WUPPERTAL, 42289, DE

(73) Assignee: Jürgen Hofinger, Dresden (DE)

(21) Appl. No.: 11/997,163

(22) PCT Filed: Jul. 29, 2006
(86) PCT No.: PCT/DE2006/001363

§ 371 Date: Jul. 30, 2008

(30) Foreign Application Priority Data
Jul. 29, 2005 (DE) 10 2005 036 684.8

(51) Int. Cl. B05D 3/10; B32B 15/00; B01J 31/02; B03C 3/40

(52) U.S. Cl. 502/150; 428/457; 428/458; 427/337; 204/660

(57) ABSTRACT

A substrate with spatially selective metal coating is produced by first applying biological templates onto parts of the surface of the substrate and applying a metal coating only once the biological templates have been deposited on the substrate. The biological templates are for example surface layer proteins (S-layer) and the metal coating is a noble metal coating. The substrates with spatially selective metal coating are used in catalysts or solid-state electrolyte sensors.

The invention concerns substrates with spatially selective metal coating, method for their production, wherein the sites of metal coating on the substrate can be influenced. Moreover, the invention concerns the use of such substrates for catalysts, solid-state electrolyte sensors or optical transparent conductive layers.

Materials that lower the activation energy for starting a certain reaction and in this way increase the rate of reaction without being spent in the reaction are referred to as catalysts. Colloidal metals are known as catalysts and are produced by reduction of metal salts or metal complexes.

The size, the type and distribution of the metallic active clusters, on the one hand, and their accessibility within the support structures, on the other hand, have an important effect on the activity of noble metal catalysts.

Sleytr et al. in WO 89/09406 has patented a method for immobilization or deposition of molecules or substances on a support. The support is comprised of at least one layer of identical molecules containing protein which molecules are arranged in the form of a crystal lattice with a lattice constant of 1 to 50 nm.

WO 97/48837 discloses metallic nanostructures on the basis of self-assembled geometric highly ordered proteins as well as a method for their production. The assembled proteins are activated with a metal salt or a metal complex and can be metallized subsequently currentless in a metallization bath under conditions that are protein-compatible.

Also disclosed by Sleytr et al. in AT 410 805 B is a method for deposition of S-layer proteins in which the S-layer proteins have an electrical net charge and, by adjusting the electrical potential of the support surface, an electrochemical potential differential between the solution and the support surface is produced; under said effect the S-layer proteins will precipitate from the solution onto the support surface.

For selectively coating surfaces with noble metals, publications are known that concern applications in the field of microelectronics. In DE 692 31 893 T2 a method for the currentless metallization is disclosed in which a selective deposition of metals is realized by pretreatment of the substrate with chemical groups.

DE 199 52 018 C1 discloses a method in which decorated substrates are produced in the nanometer range. The method is based on the positioning of polymer core-shell systems in depressions of a photoresist layer that is structured by lithographic techniques.

All techniques that are disclosed in the literature achieve a selective deposition of metals on surfaces either serially by a writing or positioning method with the aid of a positionable device or by masking methods. Serial processes are very slow in particular with regard to producing small structures and therefore are too expensive for many applications. In the case of masking processes, pre-manufactured patterns can be transferred onto the surface, for example, by means of lithographic masks or by stamping techniques, and can thus be utilized multiple times. The serial as well as the masking methods however require accessibility of the surface for the structuring process.

DE 199 30 893 B4 discloses the use of highly ordered proteins that are occupied by insular clusters of a catalytically active metal as a support-fixed catalyst for chemical hydrogenation in which the proteins covered with clusters remain unchanged. The highly ordered proteins serve as a support on which the metallic clusters are deposited in more or less regular form, i.e., structuring of the clusters in this case is achieved at best by a regular structure of the self-organized proteins. The utilization of the proteins for the selective deposition of the metallic clusters on the substrate underneath by incomplete coating and thus the prevention of metal deposition on unwanted sites is not disclosed.

DE 102 28 056 A1 discloses a method for generating nucleation centers for the selective heterogeneous growth of metal clusters on DNA molecules. The DNA molecules are metalized in an aqueous solution in the presence of metal salts and reducing agents. The nucleation centers provide an excellent template so that for a suitable process control the homogenous nucleation of metal clusters in the solution can be prevented. However, no additional support materials that can also act as nucleation seeds are present in the solution. In particular, the DNA molecules are not deposited before metallization on support surfaces. The selectivity of the deposition is thus based on the suppression of homogenous nucleation as well as the possibility of partial metallization of the DNA molecules by affecting the base sequences of the DNA.

New applications of catalytic methods, for example, in fuel cell technology, as well as greater challenges in regard to the efficiency of catalytic methods have led to the development of new catalyst supports. They latter have a more or less controlled inner micro structure and therefore cause an intensive contact of the gases and liquids to be catalytically treated with the catalytically active centers of the catalyst. However, the metallic clusters deposited on the support by far do not all have the same activity. Likewise, not all deposited clusters are equally accessible for the gases or liquids to be catalytically treated. As a result of the high prices and the expected scarcity of noble metal resources, a better utilization of the employed noble metals in the catalysts is desirable.

The object of the invention reside therefore in providing substrates with a spatially selective metal coating and methods for their manufacture in which the sites of the metal coating on the substrate can be affected.

According to the invention, the object is solved by a substrate with spatially selective metal coating whose surface has partially biological templates with a metallic coating and that can be obtained in that the metallic coating is carried out only after the biological templates have been deposited on the substrate.

The metal coating provided according to the invention is located on the biological template.

In an advantageous embodiment of the invention, the biological templates are surface layer proteins (S-layer).

The metallic coating can be comprised of metal clusters and/or at least one metal layer. In this connection, metal cluster and metal layer can be comprised of different metals. Metals are preferably selected from noble metals, for example, Pt, Pd.

The substrate is comprised preferably of Al₂O₃, silicon, carbon, or a solid-state electrolyte.

According to the invention, the object is solved by a method for producing a substrate with a spatially selective metal coating in which method biological templates are deposited on the substrates and subsequently are metalized under conditions that are compatible with the biological templates or in which biological templates are activated in metal salt solution, are subsequently deposited on the substrates, and then metalized under compatible conditions for the biological templates.

According to the invention, the metal coating is not located directly on the substrates but on the biological templates with which the substrates have been coated beforehand. The biological templates enable in this connection a control of the deposition location as result of their selectable size and chemical or physical properties. According to one embodiment of the invention, the biological templates can be activated in metal salt solution before deposition on the substrate surface. in this way, already before coating of the substrate the efficiency of the nucleation centers of the bio template is increased and the metallization process on the substrate can be accelerated. The activation is achieved by mixing a suspension of the bio template with a metal salt solution over several hours.

As a biological template self-organizing biological templates are preferred, primarily surface layer proteins (S-layer).

Numerous bacteria form in their cell walls periodic protein membranes. In these membranes, nano pores with species-dependent crystal symmetry are arranged with great regularity. The spacing of neighboring units of same morphology is 5 to 30 nm, depending on the type. Because the structural units are comprised of identical proteins or glycoproteins, they have a precise spatial modulation of the physical-chemical surface properties. This makes them an ideal object for constructing artificial supramolecular structures. Nanometer-sized cluster arrangements arranged in a regular pattern can be generated thereon. The ability for self-organization of the monomers enables reconstruction of the two-dimensional protein arrangements at the water/air boundary as large surface area protein membranes on solid-state surfaces. In this way it is possible to deposit in a defined way metallic nanostructures on surfaces of catalyst supports or sensors by means of the S-layer.

The deposited metals are preferably noble metals. Currentless metallization is preferred as a method for the metal deposition of the metallic clusters on a biological template. In this connection, metal complexes are bonded to a surface and are reduced by a subsequent process to metals and metal clusters are then formed.

According to the invention, first the biological template is deposited on the substrate, for example, a substrate suitable for catalysts. The biological templates act then as seeds for a preferred deposition of noble metal clusters on their surface because the metal deposition on the template is energetically preferred in comparison to a direct deposition on the substrate. With a suitable process control, a selective deposition of the membrane on sites that are preferred for catalysis can thus lead to an exclusive deposition of catalytically active noble metal clusters on the substrate in a way optimal for the catalytic reaction.

In a further embodiment metal complexes are bonded onto the membrane-like structures already in a metal salt solution. After controlled deposition on the desired locations on the substrate the metal complexes are reduced by suitable processes to metallic clusters.

When depositing biological templates on substrate surfaces provided with meso pores or nano pores, the deposition can be controlled based on the size and structure of the biological templates so that in the subsequent metal coating step centers are produced that are accessible or effective for the catalysis. The diffusion of noble metal complexes as well as the deposition of noble metal clusters at greater depths of porous structures are not advantageous for the gases or liquids to be catalytically reacted because of the minimal accessibility. The selective metal deposition on the biological template prevents the generation of ineffective metal clusters and thus the uncontrolled loss of the expensive noble metal resources.

According to a further preferred embodiment, the biological template has a uniform nano structure with regard to its properties as a seed former as well as with regard to its geometric shape which nanostructure in the process of deposition of the metallic clusters enhances a homogenous and dense arrangement with a narrow size distribution.

According to the invention, biological templates are employed for occupying the surface. In contrast to presently known structuring methods, further techniques can be utilized for a selective deposition.
Because of the effect of the adsorption of bio templates in solution on surfaces a selective deposition can be realized by locally differing flow conditions. For example, in case of a flow passing through complex support structures with inner surfaces, a selective coating can be realized in areas that are exposed to the flow to different degrees. For a correspondingly minimal concentration of the biomolecules in the solution, an increase of the flow rate and/or a longer flow duration in the areas with great flow a complete coating of the surfaces with bio templates can be achieved. In the areas with weak flow, during the same time significantly fewer biomolecules are presented by the solution on the other hand so that a deposition is realized at a substantially decreased level. In conventional immersion coatings the opposite effect can be observed because the coating solution upon drying will stay especially within areas with weak flow.
Depending on the size of the bio templates or their aggregates the penetration into pores of the surface to be coated can be impaired. The bio templates are then selectively deposited only on the surface or in pores of a certain size and above. Biomolecules have a defined configuration and are therefore present also in a specified size. Moreover, the size of the biomolecules can be controlled by the formation of aggregates. In this connection, a control of the number of the participating biomolecules is possible in order to generate again a defined size.
Specific binding mechanisms of biological templates can be utilized in order to achieve a variation of chemical and/or physical properties on material surfaces for a selective deposition. The direct deposition of metallic clusters is however significantly less specific.
The deposition of biological templates can be controlled by electrical fields. This effect can also be utilized in a targeted fashion for a selective occupation of the surface with bio templates. In contrast to metallic clusters, in the case of biomolecules different surface charges can be utilized in order to achieve a preferred deposition on areas of the substrate surface that have an opposite charge and thus effect electrostatic attraction. Also, a charge on the substrate surface with same sign can thus prevent deposition. A varied surface charge can be achieved very simply, for example, by a geometric structuring of a charged surface. The charges then are concentrated at local corners and edges.

Usually, in the case of a chemical coating of surfaces with metals by reduction, the formation of clusters takes place in the solution (homogenous nucleation) as well as on the substrate to be coated. It is known that by means of a suitable pretreatment of surfaces and appropriate process control the homogenous nucleation can be suppressed extensively. The formation of metallic clusters then takes place exclusively on the surface and leads to a more or less uniform coating of the surface. As a result of the selective occupation of the surface with biological templates according to the invention, not only the homogenous nucleation in the solution can be prevented but also the coating of the neighboring bio template-free areas with metallic clusters can be prevented. Only in this way is it possible to transform the selective occupation of the surface with bio templates into a selective coating with metallic clusters or layers.

This effect does not occur in prior art substrates for catalysts and therefore was not to be expected.

An important feature of the invention is the avoidance of deposition of metals at locations where deposition is not required for the application or is detrimental to the application. Examples are noble metal catalysis in which the deposition of noble metals that do not participate in the catalytic reaction represents a significant cost factor as well as sensor surfaces in which the sensory effect is achieved only after structuring of the layer.

On the biological templates, metal clusters and/or metal layers can be deposited. Metal cluster and metal coating can be comprised of different metals. Preferred are noble metals such as platinum, palladium.

In this connection, the deposition of metallic clusters is always the first step in the coating process. A continued cluster deposition leads first to mutual contact of an increasing number of clusters so that finally closed layers are produced. As soon as a continuous conductivity is achieved, the process can be continued with electrochemical coating techniques. When the clusters deposited in the first step are comprised of sufficiently noble metals, the further coating can be continued also with other metals, for example, nickel, cobalt or copper. For this purpose, methods of currentless metallization as known in the art are utilized.

Substrates of Al₂O₃, silicon, carbon, a solid-state electrolyte or a transparent electrically conducting layer are used as substrates for the method.

The invention also encompasses the use of substrates according to the invention for catalysts, solid-state electrolyte sensors or optically transparent, electrically conducting layers.

Heterogeneous catalysts are comprised of a support through which the gases or liquids to be catalytically reacted are passed. The support is comprised of a catalytically active material or coated with particles of the catalytically active noble metals in the case of noble metal catalysts. In contrast to a closed metallic coating, the deposition of fine clusters typically in the range of 1 to 50 nm has the advantage of a larger surface area for the same noble metal volume. In order to further increase the surface area, it is conventional to carry out the deposition of the metallic clusters on an intermediate support that is usually present also in the form of particles and on which the actual support is deposited as a coating. This intermediate support has a large inner surface area (e.g., gamma aluminum oxide or active carbon). Accordingly, significantly more noble metal particles can be deposited thereon in comparison to the actual support surface so that the catalytic activity is increased. The penetration of the metal salt solution into the pore structure of the intermediate support however happens in a relatively uncontrolled way. A significant portion of the entire porosity of these materials however is in the form of very small pores. As a result of the high flow resistance a contact of the gases or liquids to be catalytically reacted in the application is made more difficult or not possible at all. The utilization of biological templates in accordance with the invention enables in this case a selection of the deposition sites based on the template size. The subsequent deposition of the metal clusters on the biological structure prevents thus the uncontrolled loss of expensive noble metal resources while the catalytic activity remains the same.

By means of the coating according to the invention, substrate surfaces can be provided with a high proportion of three-phase interfaces (metal coating/substrate-gas phase/liquid phase). Such substrates are suitable for solid-state electrolyte sensors.

The substrates according to the present invention are suitable also for optical transparent electrical conducting layers, for example, displays. For this purpose, on optical transparent conducting substrates biological templates are deposited that are then metallized. When configuring displays, layers are required that can dissipate electrical charges. Of course, these layers must have at the same time a high optical transparency in order not to negatively affect the optical function. Also, there are many applications for coating non-conducting substrates in which the reduction of the electrostatic charges is advantageous. At the same time, however the appearance should not be changed.

With the aid of the attached illustrations embodiments of the invention will be explained in more detail. It is shown in:

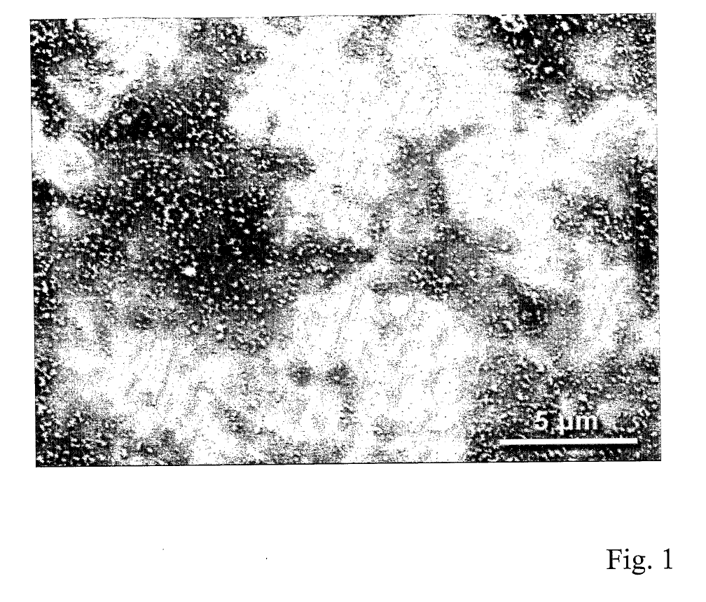

FIG. 1 SEM image of a substrate according to Example 1;

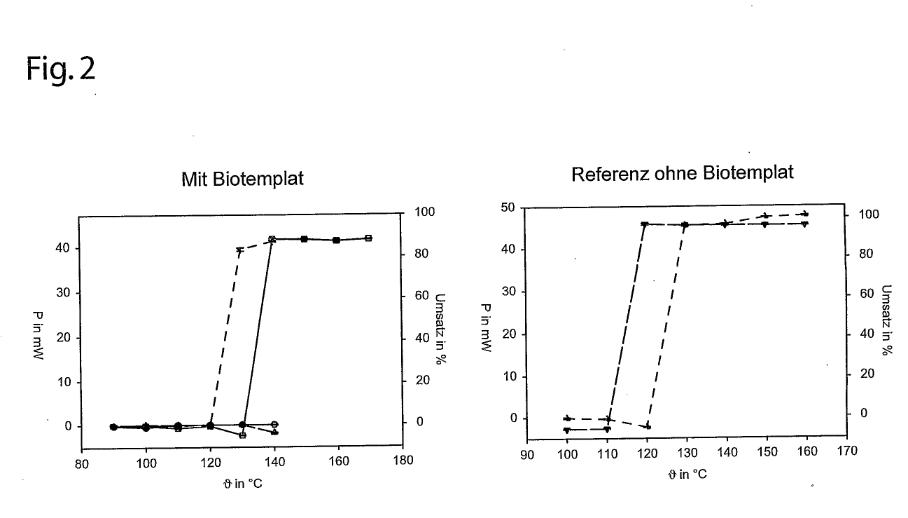

FIG. 2 DSC diagram;

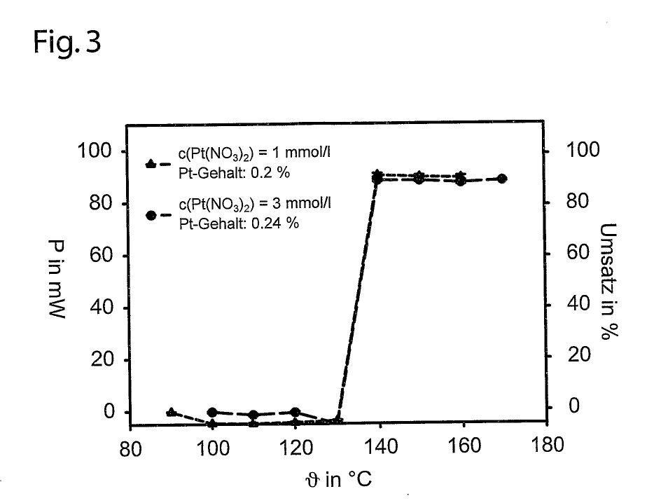

FIG. 3 DSC diagram.

### EXAMPLE 1

Targeted coating of surfaces with metal clusters by controlled coating with biological templates (S-layer patches on Bacillus sphaericus NCTC 9602).

The preparation of the S-layer is based on the publication by Engelhard, H.; Saxton, W.; Baumeister, W., “Three-dimensional structure of tetragonal surface layer of Sporosarcina urea”; J. Bacteriol. 168 (1), 309, 1986. The standard buffer for storing the isolated and purified S-layer at 4° C. is comprised of 50 mM TRIS/HCl solution with addition of 3 mM NaN₃ and 1 mM MgCl₂.

The S-layer solution for further experimental work has a standardized concentration of 10 mg/mi.

To a 3 mM solution of K₂PtCl₄ that has been prepared at least 24 hours in advance 13 l of the protein solution is added based on the calculation for the coating of the protein with metal clusters. The interaction between the S-layer solution and the metal complex solution is carried out in a time period of 24 h and with exclusion of light. After this incubation time the required number of metal complexes required for the cluster formation is bonded to the template. After adding Al₂O₃ particles as a substrate and an adsorption time of again 24 hours in which the activated biomolecules adsorb on the substrate, the substrate material is removed from the solution and subjected to several washing steps. The bonded metal salt complexes are reduced to noble metal clusters by subsequently adding hydrazine as a reducing agent to the coated substrate.

The thus prepared materials, inter alia catalytically active, are then applied for characterization and examination onto conductive foils and are examined by means of a scanning electron microscope. FIG. 1 shows an electron microscope image of a sample produced as described. The exclusive deposition of the metal clusters on the areas with biological material can be seen clearly. The example demonstrates thus the possibility of a selective deposition of metal clusters on substrates. With a further chemical metal coating as known in the art the existing clusters can be transformed into continuous metallic layers. A surface produced in this way then has the property of electric conductivity and, at the same time, a high proportion of three-phase interfaces (metal coating-substrate-gas phase or metal coating-substrate-liquid phase) is present. Substrates produced in this way can be utilized as a solid-state electrolyte sensor with particularly high sensitivity.

### EXAMPLE 2

Targeted coating of surfaces with metal clusters by controlled coating with biological templates as in Example 1 but with preceding recrystallization of the protein monomers on the substrates, respectively.

The standardized employed S-layer solution was lyophilized and subsequently suspended in a 0.8 M TRIS-buffered guanidine hydrochloride solution so that the final concentration of the protein solution is 10 mg/ml. After interaction of the reagents for 30 min., the solution is transferred into a prepared dialysis hose (VISKING type 27/32) or a dialysis chamber and dialyzed relative to water as well as subsequently relative to the standard buffer without MgCl₂. The solution present after this step in the dialysis hose is transferred into a suitable reaction vessel and is centrifuged at 4° C., 20,000 g for 10 minutes. The pellet produced by this step is discharged, the supernatant monomer solution is used for the subsequent work. (The monomer solution is stable for approximately 5 days based on current knowledge; subsequently, self assimilation products are produced).

The freshly prepared monomer solution is recrystallized with addition of MgCl₂ (final concentration 1 mM) directly onto a Si substrate. At 30° C. and a very high humidity the protein monomers recrystallize within 24 h on the Si substrate in a monolayer. After several washing steps the Si substrate functionalized in this way is contacted with a metal complex solution and subsequently, as in example 1, is coated with metallic clusters.

The advantage of recrystallization of protein monomers directly on the Si substrate in comparison to a deposition on S-layer patches is the formation of a monolayer of protein and the thus resulting reduced amount of biological material. The proportion of surface area coated with bio templates can be controlled by external parameters (for example, temperature, pH value of the solution). As in Example 1, the thus produced substrate is suitable as a three-phase interface area of a solid-state electrolyte sensor.

### EXAMPLE 3

Targeted coating of surfaces with noble metal clusters exhibiting catalytic activity on exhaust gases by controlled coating with biological templates (S-layer patches of Bacillus sphaericus NCTC 9602) with elimination of use of chlorides and hydrazine.

The preparation of the S-layer is based on the publication by Engelhard, H.; Saxton, W.; Baumeister, W., “Three-dimensional structure of tetragonal surface layer of Sporosarcina urea”; J. Bacteriol. 168 (1), 309, 1986. The standard buffer for storing the isolated and purified S-layer (4° C.) is comprised of 50 mM TRIS/HCl solution with addition of 3 mM NaN₃ and 1 mM MgCl₂.

The S-layer solution for all further experimental work has a standardized concentration of 10 mg/l.

Aluminum oxide particles (100 mg each) are suspended in 825 l of the activated S-layer solution and allowed to interact for 24 h. Subsequently, two washing steps with distilled H₂O are performed.

To the particles coated with S-layer, 10.83 ml Pt(NO₃)₂ solution is added, admixed and incubated for 72 h with exclusion of light at room temperature. During this time the bonding of the Pt complexes to the S-layer proteins that is required for the cluster formation takes place.

The supernatant is discharged and the particles are washed once again twice with distilled H₂O.

The following reduction to metallic platinum is induced by adding 2.4 ml NaBH₄ to the aluminum oxide particles. As an indicator for termination of reduction the gas development can be utilized. Reduction should be completed after 30-60 minutes.

The supernatant is discharged again. Two washing steps with 10 ml distilled H₂O each are performed and followed by drying of the products at 40° C.

For the visual characterization of the Pt cluster deposition examinations by scanning electron microscope are suitable. For evaluating the catalytic activity, a reference preparation is carried out that is performed in accordance with the same procedural protocol but without biological templates. FIG. 2 shows the results of DSC measurement (differential thermal analysis) for evaluating the catalytic activity. The catalyst produced by utilization of the biological templates shows a comparable catalytic effect (reaction temperature only 10° C. above the reference catalyst). The determination of the contained platinum shows however significant savings (reduction of platinum contents from 1.1% to 0.24%). A repetition of the experiment with changed concentration of the platinum solution by utilizing the bio templates shows that the catalytic activity as well as the contained platinum amounts in the catalyst is independent of the concentration utilized in the process. This indicates clearly that the deposited amount of platinum is determined and thus controlled only by the bio template (FIG. 3).

What is claimed is:

1.-17. (canceled)

18. A substrate with spatially selective metal coating, the substrate having a surface that is provided partially with biological templates, wherein the biological templates have a metal coating, wherein the metal coating is applied to the biological templates only once the biological templates have been deposited on the substrate.

19. The substrate according to claim 18, wherein the biological templates are surface layer proteins (S-layer).

20. The substrate according to claim 18, wherein the metal coating is comprised of metal clusters; at least one metal layer; or metal clusters and at least one metal layer.

21. The substrate according to claim 20, wherein the metal cluster and the at least one metal coating are comprised of different metals.

22. The substrate according to claim 18, wherein the metal coating is comprised of noble metals.

23. The substrate according to claim 18, wherein the substrate is comprised of Al₂O₃, silicon, carbon, or a solid state electrolyte.

24. A method for spatially selective deposition of metal clusters on a substrate, the method comprising the steps of:
depositing biological templates on a substrate; and
subsequently metallizing the biological templates on the substrate under conditions that are compatible for the biological templates.

25. The method according to claim 24, further comprising the step of activating the biological templates in a metal salt solution before the step of depositing.

26. The method according to claim 24, wherein in the step of metallizing metal clusters; metal coatings; or metal clusters and metal coatings are deposited.

27. The method according to claim 24, wherein the step of metallizing is carried out currentless in at least one metal salt solution.

28. The method according to claim 24, wherein the step of depositing is carried out by changing a concentration or a flow rate of a solution that contains the biological templates and is employed for depositing.

29. The method according to claim 24, wherein in the step of depositing the size of the biological templates and bonding mechanisms are utilized for targeted deposition.

30. The method according to claim 24, wherein in the step of depositing electrical fields are applied for controlling the deposition of the biological templates.

31. The method according to claim 24, wherein in the step of depositing the biological templates are recrystallized as monomers on the substrate.

32. The method according to claim 24, wherein the biological templates are surface layer proteins (S-layer) and in the step of metallizing noble metals are used.

33. A catalyst comprising at least one substrate according to claim 18.

34. A solid-state electrolyte sensor comprising at least one substrate according to claim 18.
